(19) United States
(12) Patent Application Publication
(10) Pub. No.: US 2003/0023882 A1
(43) Pub. Date: Jan. 30, 2003

(54) Biometric characteristic security system

(76) Inventor: Charlie Udom, Albany, OR (US)

Correspondence Address: HEWLETT-PACKARD COMPANY, Intellectual Property Administration, P.O. Box 272400, Fort Collins, CO, 80527-2400, US

(21) Appl. No.: 09/917,013

(22) Filed: Jul. 26, 2001

(51) Int. Cl. H04L 9/32

(52) U.S. Cl. 713/202; 382/115

(57) ABSTRACT

A security system using biometric characteristics avoids lost data identifiers and lost physical keys. A biometric scanner, such as a capacitive fingerprint scanner, coupled to the processor of a personal digital assistant or cellular telephone, wirelessly transmits data representing the biometric characteristic using the Bluetooth protocol. By using a well known data communications protocol, such as the Bluetooth protocol, wireless access devices that rely upon biometric characteristics, preclude reliance upon passwords, PIN numbers, keys and other indicia used to establish authorization of a user and can function as universally accepted access keys.

### BACKGROUND OF THE INVENTION

Security systems are used to control access to real property (cars, real estate etc.) as well intangible property (bank accounts, data files, etc.) Prior art security systems typically rely on either a secret identifier (password, pass-phrase, personal identification number or “PIN”) or a physical device (a mechanical key or electronic key card or smart card) or both (an identifier and a device) in order to control who is granted access.

Security systems that rely upon an identifier (i.e. a password, pass phrase, or PIN) typically suffer from the drawback that a user must be able to provide the identifier. If the user loses or forgets the identifier, the user is denied access and/or usage. Security systems that rely upon a physical device suffer from the drawback that keys, key-cards and smart cards are frequently lost or stolen thereafter precluding a legitimate user's access.

Instead of passwords or keys, biometric characteristics (e.g., finger prints, retinal scans and voice “prints”), which uniquely identify an individual, can be effectively used to reliably identify an individual and do not suffer from the aforementioned drawbacks of electronic security systems that use identifiers or physical devices. Security systems that use biometric characteristics are better than systems that use an identifier or a device in that an authorized user presumably never loses his or her finger prints, retinas or voice characteristics.

### SUMMARY OF THE INVENTION

A security system controls access to goods and services, computer files, bank accounts, or physical areas, using a biometric-characteristic scanner coupled to a computer, which is in turn coupled to a wireless communications device to provide a simple, reliable access/entry mechanism. In one embodiment of the invention, a fingerprint scanner coupled to a personal digital assistant (PDA), which is in turn coupled to a so-called “Bluetooth”-compliant wireless data link, provides a wireless security system access device.

### BRIEF DESCRIPTION OF THE DRAWINGS

FIG. 1 shows a simplified block diagram of a security system comprised of a security access device employing a biometric scanner and a wireless data link.

FIG. 2 shows a simplified flow chart of the steps of the method by which a biometric characteristic can be used to control access to a secured area or resource.

### DETAILED DESCRIPTION OF THE PREFERRED EMBODIMENT

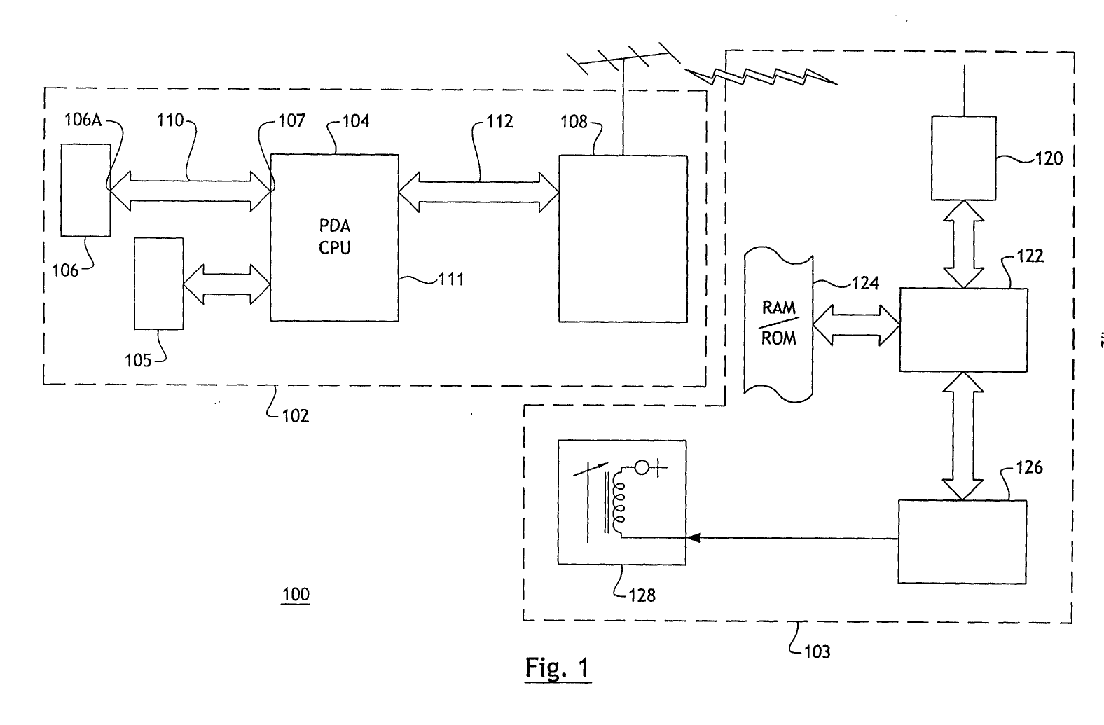

FIG. 1 shows a simplified block diagram of an electronic security system 100 comprised of a wireless biometric-characteristic-sensing security device 102 in combination with a wireless base station 103. The security system 100 can be used to control access to property (e.g., cars, real property) and services as well as resources such as computer data, bank accounts, and the like. The security device 102 relies upon biometric characteristics to grant or deny access and therefore does not require a user to remember any sort of password nor does it require the user to have possession of any sort of physical device such as key or smart card.

The biometric characteristic security device 102 is comprised of a biometric characteristic scanner 106, the output of which 106A is coupled to a processor 104. The output 111 of the processor 104, is coupled to the input of a wireless communications device 108. In a preferred embodiment, the processor 104 is implemented using the processor of a personal digital assistant or “PDA” but which also has an input data port 107 through which data signals (such as those from a biometric scanner 106 described hereinafter) can be sent and received.

Predetermined-format data signals that are generated in (or originate from) a biometric scanner 106 and are coupled into the PDA processor (i.e. CPU) via a data and control bus 110 (hereafter “data bus 110”). The PDA processor output port 111 enables data signals from the scanner 106, which have been processed by the CPU 104, to be sent to and from the wireless data transmitter 108 via an address and control bus 112. Data and program instructions that are executed by the processor 104 of the PDA are stored in, and accessed from, a memory device 105, typically implemented as a random access memory (RAM) or read only memory (ROM), electrically erasable programmable read only memory (EEPROM) device or other memory devices, various embodiments of which are well-known to those skilled in the art.

In a preferred embodiment, the biometric characteristic scanner (also sometimes referred to as a “sensor”) 106 is a capacitive fingerprint sensor available from at least Veridicom, Inc. of Santa Clara, Calif. the specifications of which are available at the time of filing this application at www.veridicom.com. The terminology “biometric scanner” is used herein to refer to devices that can electronically read or “scan” a particular biological (bio-) measurable (metric) characteristic such as a finger print pattern, retinal pattern, or a “voice print” pattern. A finger print, retina and the audio-frequency components of a voice are all biometric characteristics that can be used to identify an individual.

At the time of filing this application, biometric scanners (or sensors) are also available from Ethentica, Inc. of Aliso, Viejo, Calif. Ethentica's product specifications and other data about tactile fingerprint sensors are available on the Ethentica website at www.ethentica.com. Still other types of biometric sensors 106 would include retinal scanners and voice recognition devices, which, among other things, can identify the distinctive frequency components and waveforms of an individual's spoken voice.

In the preferred embodiment, a fingerprint sensor, (such as the Veridicom model FPS 110 sensor) provides a relatively high resolution “image” of the peaks and valleys of an individual's fingerprint using a matrix of parallel plate capacitors, one plate of each of which is formed by a users' finger tip surface and the other one of which is one of 90,000 or more “plates” formed on the finger print sensor. When an individual places his finger on the sensor, the finger acts as one of the plates of a dual plate capacitor. The other plate is formed on the silicon chip containing an array of capacitor plates.

According to data provided by Veridicom on its web site as of the filing date of this application, the Veridicom devices are capable of sensing finger print characteristics at a relatively high resolution of 500 dots per inch. The Veridicom module can create a raster-scanned image of the ridges and valleys of the finger pressed against the chip. The raster scan image data is converted by the Veridicom device to a video signal that is represented by 8 bit digital words, which can be read by the central processing unit 104 via the address and control bus 110. The 8 bit words representing a raster can be even further processed, such as by computing a one-or-more byte checksum, to even further compress or truncate the volume of data required to represent a biometric characteristic.

In one embodiment, the process of verifying an individual's identity and authorizing that person to have access to a secure resource (e.g., a bank account, computer data, automobile, or other valuable intangible or tangible property item), the software within the CPU 104 compares data from the sensor 106 that represents a scanned biometric characteristic, to either data or data templates stored for various individuals in memory 105. (The term “data templates” refers to compressed, modeled, sampled or other truncation of raw scanner data, which can be stored in smaller amounts of memory than would be required to store the raw data of a scan, yet reliably identify an individual notwithstanding its truncation. For purposes of this disclosure and in particular, claim construction, “data” and “data templates” and truncated data representing a biometric characteristic are all considered to be equivalents of each other.) If after comparing the data from the sensor 106 to stored data or data templates of biometric characteristics of authorized individuals, the software within the processor 104 rejects the access attempt, the individual identified by the data from the sensor 106 is denied access. If the biometric data from the sensor 106 substantially matches data of an authorized individual, that person is granted access by the base station 103 authorizing the person to access the secured asset. In FIG. 1, the base station 103 is shown as including a solenoid 128 that can be used to lock or unlock a physically secured asset. Instead of a solenoid 128, the base station 103 might also enable or disable access to computer accounts or data files.

In some instances, a stored representation of a biometric characteristic might not identically match a contemporaneously obtained sample. By way of example, an injury might preclude an exact match of a finger print image from a scanner to a stored sample thereof. In such instances, software that measures the correspondence between a contemporaneous sample and a stored sample must evaluate the degree, or amount by which the two images differ. One method by which images could be compared is a pixel-by-pixel comparison. The acceptable number or level of differences between a stored representation of a biometric characteristic and a characteristic just read is a design choice. In some instances where maximum security is required, a 100% correspondence might be necessary. In other instances, a reasonable certainty of identification might be considered to be tolerable. Methods to compare a scanned biometric characteristic to a stored or archived characteristic are known in the art.

In the embodiment wherein the wireless security device 102 makes the determination that a user is authorized (by performing a comparison set forth above) the processor 104 forwards an appropriate data signal via an address and control bus 112 to a radio frequency (RF) modulator/transmitter 108 for broadcast to a corresponding security system comprised of a receiver 120, a CPU 122 and corresponding memory 124 and an access control device 126. Examples of signals that indicate that the security device 102 has made an identification by comparing biometric data scanned from an individual to biometric stored within the device 102 include, but are not limited to, single or multibyte data messages transmitted by the device 102 that might or might not be encrypted prior to transmission. By way of example, if a user's thumb print substantially matches a stored print of an authorized person, a predetermined data word is transmitted from the wireless security device 102 to the base station 103. Upon receipt of the data word signal, the base station can effectuate access to the secured resource or property as set forth below. If on the other hand an individual's finger print does not match, a similar denial or rejection data message can be sent to the base station 103.

In another embodiment of the invention, the security device 102 acts only as a biometric characteristic collector and forwarder. Data from the scanner 106 is read by the CPU 104 and sent to the RF modulator 108 for transmission to the base station 103. The data transmitted from the security device 102 to the base station 103 can include, but is not limited to: raw scan data from the scanner 106; data representing the raster scan of the image from the scanner 106; truncated or otherwise compressed forms of either the raw data or raster data. Upon receipt of the data by the base station 103, the base station 103 performs the process of validating a user by comparing scanned characteristics to stored characteristics. A comparison of scanned characteristics to stored characteristics can be performed in the base station such that a determination of the user's identity is assured. Data that represents a scanned biometric characteristic (or that a person has been determined to be authorized by the security device 102) is preferably encrypted by the processor 104, prior to transmission, so as to preclude the surreptitious interception of sensitive identification data.

In yet another embodiment, the biometric security device 102 first obtains a biometric characteristic of an individual from the biometric scanner 106. The raw scan data is processed by the CPU 104 using one or more processes, such as those set forth above or otherwise known to those skilled in the art, to render a truncated numeric representation of the biometric characteristic. The measured biometric characteristic as represented by the numeric representation is then compared by the processor 104 to numeric representations of biometric characteristics of one or more individuals who are authorized to access a resource or area, which are stored in local memory 105 of the biometric security device 102. Upon the processor's 104 determination that the first numeric representation of a biometric characteristic of an individual attempting access is the same as, or at least substantially the same as one or more representations stored in memory 105 of individuals who are in fact authorized, the biometric security device 102 transmits a message from the transmitter 108, signaling that it has made a determination of the person's identity. In addition to transmitting a message signaling the identity determination, the biometric security device also transmits an authenticator (also considered to be or referred to in the claims as an “identifier”) for the biometric security device itself, which uniquely identifies the biometric security device to the controller or base station 103. In such an embodiment, the base station 103 does not allow access unless the biometric characteristic is determined to be that of an authorized individual, and, the identity of the biometric device 102 as established by its authenticator is determined to be valid.

An authenticator for the security device 102 can include an encrypted or unencrypted serial number of the device 102 stored in memory 105. An authenticator for the device 102 can also include an electronic identifying code word, analogous to electronic serial numbers and or mobile identification numbers stored in and used by cellular telephones and wireless pagers. Authenticators can be stored in memory 105 or electrically programmed into local or on-chip memory of the processor 104. Electronic authentication data can also be encrypted in memory. The transmission of the authenticator can also be encrypted prior to transmission.

If the biometric security device makes a determination that a biometric characteristic at least substantially matches a stored representation for one or more individuals, and either before or after transmitting such a determination, it includes the device's authenticator, both of these pieces of data can be used to determine that an individual is authorized, and, the determination of the individuals authorization was made by an authorized security device. The security device 102 can transmit its authenticator to the base station or controller, with a signal representing that an identification of the person has also been made. The base station 103 can then determine whether the security device 102 that sent the authenticator was authorized and accept or reject the putative determination that the person is authorized to have access. A benefit to having the security device 102 authenticate itself to the base station 103 or other security controller is that resource access grants can be further controlled by disabling the ability of certain devices 102 from being used to gain access.

With respect to the biometric security device 102, the modulator/transmitter 108 is preferably a radio transmitter device compliant with the Bluetooth communications protocol, the details of which are available from the “Bluetooth” website, www.Bluetooth.com. The Bluetooth™ communications protocol is a wireless communications device connection protocol that enables various wireless communications devices (computers, phones and other devices) to communicate with each other using globally available radio frequencies ensuring worldwide compatibility. The Bluetooth technology is a product of a joint effort between 3Com, Erickson, Intel, IBM, Lucent, Microsoft, Motorola, Nokia and Toshiba. Several hundred other manufacturers are expected to adopt or comply with the Bluetooth communications protocol, the details of which are available on the Bluetooth.com website.

Bluetooth essentially provides a short range standardized communications protocol for use with wireless devices. By using the Bluetooth communications protocol, signals from the modulator/transmitter 108 can be transferred to a security or access control device the function of which is to control access to assets such as bank accounts, computer files, or physical access to real property assets. In addition to the Bluetooth protocol however, infrared signals can also be used to wirelessly transfer data between the security device 102 and the base station 103.

In using Bluetooth, as shown in FIG. 1, signals from the modulator/transmitter unit 108 of the security device 102 are received at a radio receiver 120, demodulated, and forwarded to a computer or other processor 122 for analysis.

Upon the determination that the biometric characteristic (fingerprint, retinal scan, or voice print among others) matches (or at least substantially matches) a stored parameter, the control system computer 122 might provide access to a controlled area or resource by energizing a lock mechanism or other security device 128 through an appropriate control circuit 126 as shown in FIG. 1.

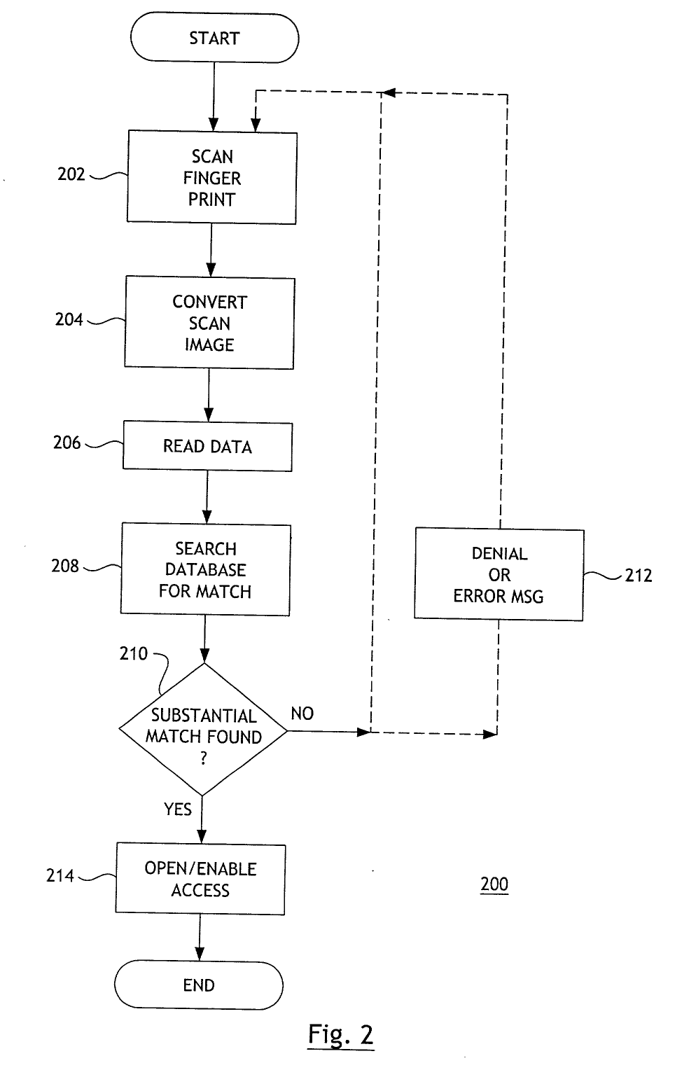

FIG. 2 shows a simplified block diagram of process steps 200 that might be employed in a biometric characteristic security system. With respect to the apparatus shown in FIG. 1, the first step of the process shown in FIG. 2 requires that a fingerprint or other biometric characteristic be scanned or measured in step 202. In the preferred embodiment, a fingerprint scan is achieved using the devices disclosed above. Other biometric scanning embodiments would require the scanning of retinal patterns or images. Still other embodiments would employ voice recognition using Fourier analysis of voice samples, the purpose or purposes of which is to render a reasonably unique numeric representation of an individual.

In step 204, a fingerprint image is converted or processed to create a video image represented by a series of 8 bit words that can be read by a computer as shown in step 206. Once data that is read in step 206 is ready for processing and further analysis, it becomes only a matter of processing power to search database records (in either the PDA or base station) as shown in step 208 for a reasonable match or correspondence between the read data from step 206 to determine if a match is previously stored.

Step 208 presumes that a database of authorized individuals was created by reading biometric characteristics and storing them in an appropriate storage medium. By way of example, individuals to whom access to a computer file is to be granted, might have their fingerprints scanned for archival purposes and stored in a database for subsequent retrieval.

In step 210, the characteristics of the scanned fingerprint as compared to those in the database are tested for correspondence and as shown in step 210, if no correspondence is found program control might loop back to the fingerprint scanning step 202 or to an error message step 212 which might be used to inform a user that his request for access or authorize was denied.

In the event that a substantial match is found, the process shown in FIG. 2 can grant such access as shown in step 214 by opening a lock, granting access to a computer, bank account or whatever resource or property value is being protected. With respect to 210, the reference to a “substantial match” refers to the possibility that image data from a fingerprint scan or a retinal scan might not match exactly with representative samples that were previously obtained and stored in a database for subsequent retrieval. In many instances, dirt or impurities on a sensor surface, injuries to a persons fingerprint or other artifacts of the scanning process might preclude an exact match between a scanned image and a stored image. As a design choice, a system user might require a certain numerical correspondence between scanned images and stored images and accept as reliable, images that do not correspond to each other at 100%.

With respect to FIG. 1, it should be noted that the radio signal broadcast from the modulator/transmitter 108 is preferably compliant with the so called Bluetooth standard. In order to further secure the integrity of the data broadcasts from the transmitter 108, such data might be encrypted prior to transmission such that a surreptitious interception does not compromise the system security by those who might capture the signal, store it, and replay it at a later time for unauthorized access.

Encrypting data representing a scanned image, and encrypting authenticators for the security device 102 is preferably performed by the CPU 104 using any appropriate encryption method. Encryption techniques are beyond the scope of this disclosure and not germane to and understanding of the disclosure hereof. In an application where a wireless security device sends access control signals and device authenticators using a well known communications standard, such as the Bluetooth standard, some form of transmitted data protection would be almost a necessity. Accordingly, decryption of an encrypted signal from the base station 103 would of course need to take place inside the processor 104 prior to its comparison to its stored biometric characteristics.

Those skilled in the art will recognize that in addition to a capacitive fingerprint sensor, the biometric scanner 106 could just as well include a retinal scanner or voice recognition system. Moreover, in addition to using a central processing unit from a personal digital assistant, processor 104 might just as well be comprised of a cellular telephone or other two-way radio communications device such as a two-way radio or a two-way pager.

For purposes of claim construction, a personal digital assistant, cellular telephone, or wireless two-way radio and its associated included processor are considered to be equivalent embodiments. All provide at least a modicum of computational capability by which signals from a scanner 106 can be read and processed. After such processing, (including encryption) the signals are transferred via a data bus to an RF transmission unit 108. Those skilled in the art will also recognize that in addition to or instead of a radio frequency transmitter, the modulator/transmitter might also be comprised of an infrared modulator by which the data signals from the processor 104 can be broadcast using infrared signals.

By use of the foregoing method and apparatus, readily available biometric sensors can be used to reliably identify a person or persons and wirelessly transmit signals by which such individuals can gain access to secured areas, computer files, databases, bank accounts and other forms of property which heretofore might be protected using passwords, personal identification numbers or electric or mechanical keys. In using biometric characteristics, that are unique to an individual, lost or forgotten passwords, PIN numbers, and keys no longer restrict access to resources, easing and simplifying security for a variety of applications and instances.

What is claimed is:

1. A biometric security device comprised of:
a biometric scanner having an output data port;
a processor having an input data port coupled to said data output port of said biometric scanner and further having an output data port;
a data transmitter having an input port coupled to the output port of said processor device.

2. The biometric security device of claim 1 wherein said biometric scanner is a finger print scanner.

3. The biometric security device of claim 1 further including a memory coupled to said processor and having stored therein at least one of: an identifier for said biometric security device and data representing a biometric characteristic of at least one individual.

4. The biometric security device of claim 1 wherein said biometric data transmitter is a Bluetooth protocol-compliant transmitter.

5. The biometric security device of claim 3 wherein said biometric data transmitter is a Bluetooth protocol-compliant transmitter.

6. The biometric security device of claim 1 wherein said processor is a personal digital assistant.

7. The biometric security device of claim 1 wherein said biometric data transmitter is an infrared transmitter.

8. A security device comprised of:
a biometric scanner, that is capable of obtaining a first biometric characteristic;
a memory having stored therein a second biometric characteristic;
a processor coupled to said biometric scanner and said memory; and
a data transmitter coupled to said processor which transmits a signal indicating that a person has been substantially identified from said first and second biometric characteristics.

9. A security device comprised of:
a biometric scanner, that is capable of obtaining a first biometric characteristic;
a memory having stored therein a second biometric characteristic and an identifier for the security device;
a processor coupled to said biometric scanner and said memory; and
a data transmitter coupled to said processor which transmits at least one of said identifier and a signal indicating that a person has been identified from said first and second biometric characteristics.

10. A biometric security device comprised of:
a personal digital assistant device having a processor coupled to an image scanner to obtain a first biometric characteristic and further having a memory coupled to said processor that stores a second biometric characteristic therein;
a data transmitter having an input port coupled to the second output data port.

11. The biometric security device of claim 10 further including a memory coupled to said processor which stores an authenticator for said personal digital assistant.

12. The biometric security device of claim 10 wherein said image scanner is a capacitive finger scanner.

13. The biometric security device of claim 10 wherein said data transmitter is a Bluetooth protocol-compliant transmitter.

14. A biometric security device comprised of:
a capacitive finger-print scanner having an output data port;
a processor coupled to said capacitive finger print scanner to obtain a first biometric characteristic;
a memory coupled to said processor;
a data transmitter coupled to and responsive to said processor.

15. The biometric security device of claim 14 wherein said capacitive finger-print scanner is a finger print scanner that generates a numerical representation of a finger-print of an individual.

16. The biometric security device of claim 14 wherein said transmitter is at least one of: an infrared transmitter and a radio frequency transmitter.

17. A biometric security device comprised of:
a retinal image scanner that obtains a first biometric characteristic;
a memory storing an identifier for said biometric security device;
a personal digital assistant having a processor coupled to said retinal image scanner and to said memory;
a radio frequency data transmitter coupled to said processor.

18. A biometric security device comprised of:
a retinal image scanner having a first data output port;
a processor having a data input port coupled to said first data output port and further having a second data output port;
a biometric data transmitter having an input port coupled to said second data output port.

19. A method of controlling access to an area using biometric characteristics of individuals comprised of:
scanning a biometric characteristic of an individual;
generating a numeric representation of said biometric characteristic;
modulating said numeric representation onto a radio frequency (RF) signal;
transmitting said RF signal to a radio receiver for analysis.

20. A method of controlling access to an area using biometric characteristics of individuals comprised of:
obtaining a first biometric characteristic of an individual;
generating a first numeric representation of said first biometric characteristic;
comparing said first numeric representation to a second numeric representation of a biometric characteristic of an individual authorized to have access to said area;
upon the determination that said first numeric representation is at least substantially the same as said second numeric representation, modulating said first numeric representation onto a radio frequency (RF) signal;
transmitting said RF signal to a radio receiver for analysis.

21. The method of claim 20 wherein said step of obtaining a first biometric characteristic is comprised of the step of optically scanning a first biometric characteristic.

22. A method of controlling access to an area using biometric characteristics of individuals comprised of:
obtaining a first biometric characteristic of an individual;
generating a first numeric representation of said first biometric characteristic;
modulating said first numeric representation onto a radio frequency (RF) signal;
transmitting said RF signal to a radio receiver for demodulation;
after demodulating said RF signal, comparing said first numeric representation to a second numeric representation of a biometric characteristic of an individual authorized to have access to said area;
upon the determination that said first numeric representation is at least substantially the same as said second numeric representation, enabling access to said area.

23. The method of claim 22 wherein said step of obtaining a first biometric characteristic is comprised of the step of optically scanning a first biometric characteristic.

24. A biometric security device comprised of:
a capacitive finger print image scanner obtaining a first biometric characteristic;
a personal digital assistant device having a processor coupled to said capacitive finger print image scanner;
a memory coupled to said processor and storing at least one of a second biometric characteristic and an identifier for said biometric security device;
a Bluetooth communication protocol-compliant data transmitter coupled to said processor and capable of transmitting at least one of said identifier, said first biometric characteristic, and a signal representing the results of comparing said first biometric characteristic to said second biometric characteristic.
